(19) United States
(12) Patent Application Publication
(10) Pub. No.: US 2010/0283262 A1
(43) Pub. Date: Nov. 11, 2010

(54) Energy Recovery And Cooling System For A Hybrid Machine

(75) Inventors: Jeffrey E. Jensen, Dunlap, IL (US); Brian Howson, Peoria, IL (US); David M. Spurtlock, Metamora, IL (US); Michael J. Barngrover, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/463,572

(22) Filed: May 11, 2009

(51) Int. Cl. H02K 7/18; F02G 3/00; F01P 9/02

(52) U.S. Cl. 290/1 R; 60/616; 123/41.2; 903/903

(57) ABSTRACT

An apparatus for a hybrid machine is disclosed. The apparatus includes a fluid pump operably connected to a condenser and a fluid path operably connected to the fluid pump. The fluid receives thermal energy from a first machine component and a second machine component. The first machine component has a static operating temperature equal to or lower than the second machine component.

### TECHNICAL FIELD

This disclosure relates generally to an energy recovery and cooling system for a hybrid machine. In particular, the disclosure relates to a system for successively recovering and using thermal energy from a plurality of machine components on a hybrid machine.

### BACKGROUND

As the cost of traditional fossil fuels rise, many industries are devoting more attention and resources to reducing fuel consumption. One common approach is to employ a “hybrid” power system in a machine such as a construction machine or passenger vehicle. For purposes of this disclosure, a hybrid system may be generally defined as a power system that includes an energy storage device, such as a battery, in addition to fuel storage for an internal combustion engine.

In normal operation of a machine, system inefficiencies create heat that must be dissipated by a cooling system. Excessive heat can damage sensitive components such as electronic equipment. In an electric hybrid system, heat is generated from machine components such as the battery, power electronics, engine, and exhaust system. Further, these machine components do not usually operate at the same temperature, and each machine component may tolerate heat build up differently. One or more of the machine components may require a cooling system to keep the component within its allowable operating temperature. Such cooling systems consume energy and therefore may increase fuel consumption. In addition, waste heat is often vented to the atmosphere through an exhaust pipe or other means, which represents a lost opportunity to use the heat for useful work necessary to power the machine.

Various methods and systems exist in the art to utilize was heat to increase the energy conversion efficiency of an overall system. For example, U.S. Pat. No. 5,191,766 to Vines discloses an internal combustion/steam engine that utilizes waste heat to generate steam under pressure to augment the power produced by the fuel burn of the engine. The steam may serve to power an engine cooling system.

While the system disclosed in Vines may succeed in increasing overall system efficiency, it does not allow for cooling of other additional system components, and does not take into consideration that different machine components may operate at different optimal temperatures, each of which may need to be sufficiently cooled to such different operating temperatures.

The present disclosure is directed to overcoming or mitigating one or more of the problems set forth above.

### SUMMARY

In one embodiment of the disclosure, an apparatus includes a fluid pump operably connected to a condenser and a fluid path operably connected to the fluid pump and to a turbine. The fluid path is in thermal communication with a first machine component and then a second machine component, and the first machine component has a static operating temperature equal to or lower than the second machine component.

In another embodiment of the disclosure, a cooling system for a machine is provided. The cooling system includes a fluid pump for pumping a fluid along a fluid path. The fluid is in thermal communication with first and second machine components such that, along the fluid path, the second machine component is downstream from the first machine component and has a static operating temperature equal to or higher than the first machine component. The system also includes a turbine oriented downstream from the second machine component along the fluid path and configured for actuation by the fluid. The system further includes a condenser oriented downstream from the turbine and upstream from the fluid pump along the fluid path, and an internal combustion engine operably connected to a drivetrain for providing propulsion to the machine.

In another embodiment of the disclosure, a method for cooling machine components is provided. The method includes the step of pumping fluid along a fluid path in thermal communication with a first machine component. The method further includes the step of pumping fluid along the fluid path in thermal communication with a second machine component, where the second machine component has a static operating temperature equal to or greater than the static operating temperature of the first machine component. The method also includes the step of employing the fluid to power a turbine operably connected with the fluid, and condensing the fluid for reuse along the fluid path.

### BRIEF DESCRIPTION OF THE DRAWINGS

FIG. 1 is a schematic illustration of a system in accordance with an embodiment of the present disclosure.

### DETAILED DESCRIPTION

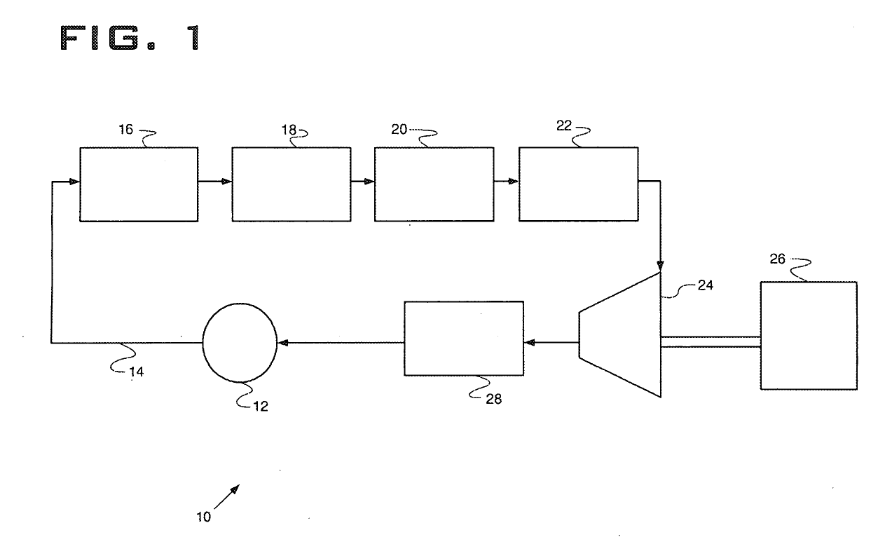

FIG. 1 shows an exemplary apparatus 10 for energy recovery and cooling in a hybrid machine. The general term “machine” as used herein may include many types of specific machines employing an internal combustion engine, such as automobiles, trucks (both on or off highway), construction and mining equipment (e.g., excavators, tractors, loaders, graders, etc.), marine vessels, aircraft, and industrial power generation systems. The machine may be a fixed or mobile machine. The internal combustion engine may be an internal combustion engine of the diesel, gasoline, or gaseous fuel-drive type, or any like type of engine.

Apparatus 10 includes a fluid pump 12, a fluid path 14, and a plurality of machine components. Fluid pump 12 pumps a fluid along fluid path 14. The fluid may be any type of common fluid used for cooling or for powering a turbine, such as water/steam, air, or common gases. Fluid is pumped by fluid pump 12 along fluid path 14 to exchange thermal energy with a plurality of machine components. Fluid path 14 may be composed of a variety and combination of structures to allow circulation of fluid. For example, fluid path 14 may include hoses, channels, or other structure components designed to carry fluid. Heat exchangers, insulators, and similar components may also help optimize and appropriately allow thermal communication between the fluid path 14 and a plurality of machine components.

In FIG. 1, the fluid first exchanges thermal energy with first machine component 16. First machine component 16 may include any component of a machine that may require cooling. For example, first machine component 16 may be a battery, an electrical circuit or system (e.g., machine electronics and control systems), an engine cooling system (e.g., an engine jacket of an internal combustion engine), an engine exhaust system, or a mechanical system generating heat through friction. In addition, first machine component 16 may be a plurality or combination of these types of components. For example, first machine component 16 may be a chamber including a plurality of different types of devices (e.g., a group of batteries, or a series of electrical circuits, or a series of different electronic devices).

If first machine component 16 is operating at a higher operating temperature than the temperature of the fluid, thermal energy may be transferred from first machine component 16 to the fluid as the fluid is pumped along fluid path 14.

The fluid may then proceed through fluid path 14 to exchange thermal energy with more machine components. The machine components along fluid path 14 in the direction of fluid flow may be considered “downstream” from earlier machine components. In FIG. 1, the fluid exchanges thermal energy successively with second machine component 18, third machine component 20, and fourth machine component 22. Each of these machine components may include the same type of machine components as described above with respect to first machine component 16. However, each successive machine component along fluid path 14 may have a static operating temperature equal to or higher than the previous machine component.

For example, in the embodiment shown in FIG. 1, first machine component 16 may be a battery operating at about 50° C. Second machine component 18 may be a cluster of power electronics operating at about 70° C. Third machine component 20 may be an engine jacket operating at about 110° C., and fourth machine component 22 may be an engine exhaust system operating at about 400° C. These numbers are used for exemplary purposes only, and are not meant to suggest, however, that particular machine components must necessarily operate at these temperatures.

As used herein, the term “normal static operating temperature” refers to the general operating temperature of the machine component during regular operation of the machine. Of course, in operation of the machine, various machine components may, for myriad various reasons, exceed or fall below the normal static operating temperature of that machine component. For example, a machine component may cease to operate or may overheat, causing its operating temperature at a given time to fall outside of its normal static operating temperature. These variations can be appreciated by one of skill in the art not to alter the scope or nature of the disclosure herein. For purposes of this disclosure, the more important attribute is that under normal operation of the machine, a plurality of machine components may exist that have different normal operating temperatures. This allows the fluid passing along fluid path 14 to successively gain thermal energy from the successive machine components as the fluid passes.

In the example of FIG. 1, as the fluid passes fourth machine component 22, the fluid is used to power a turbine 24. Turbine 24 may be a steam turbine, including a two-phase turbine that extracts energy from a liquid-gas mixture and condenses at least a portion of the gas in the liquid-gas mixture into a liquid. Turbine 24 is operably connected to power component 26, which uses the mechanical energy created by the rotation of turbine 24. Power component 26 may be, for example, a driveshaft, an electric generator, or a condenser fan. The electric generator may be electrically connected to one or more batteries for charging. The fluid then passes through condenser 28 to be pumped through fluid path 14 for another cooling cycle. A throttle valve or other throttling device (not shown) may be located in the fluid path 14 to selectively restrict the flow rate and/or pressure of fluid entering turbine 30.

Alternatively, power component 26 may be a radiator fan. This alternative configuration may be advantageous because, as the plurality of machine components generates additional heat, more power may be provided to turbine 24, which in turn, may provide more power to the radiator fan (increasing the speed of the fan) to increase cooling. Thus this configuration is dynamically adaptable to adjust to variations of the heat generated by the plurality of machine components.

### INDUSTRIAL APPLICABILITY

The present disclosure provides an advantageous apparatus and system for energy recovery and cooling in a hybrid machine. The disclosure may help improve the fuel economy of a machine by recovering additional energy and putting recovered energy to effective use to power machine systems, while simultaneously cooling a plurality of machine components.

Other embodiments, features, aspects, and principles of the disclosed examples will be apparent to those skilled in the art and may be implemented in various environments and systems.

What is claimed is:

1. An apparatus comprising:
a fluid pump operably connected to a condenser;
a fluid path operably connected to the fluid pump and to a turbine;
wherein the fluid path is in thermal communication with a first machine component and a second machine component downstream of the first machine component along the fluid path,
wherein the first machine component has a static operating temperature equal to or lower than the second machine component.

2. The apparatus of claim 1, wherein the first machine component or the second machine component includes a battery.

3. The apparatus of claim 1, wherein the first machine component or the second machine component includes an engine exhaust system.

4. The apparatus of claim 1, wherein the first machine component or the second machine component includes machine electronics.

5. The apparatus of claim 1, wherein the first machine component or the second machine component includes an engine cooling system.

6. The apparatus of claim 1, including a driveshaft operably connected to the turbine.

7. The apparatus of claim 1, including an electric generator operably connected to the turbine.

8. The apparatus of claim 7, wherein the electric generator is electrically connected to a battery.

9. The apparatus of claim 1, including a condenser fan operably connected to the turbine.

10. The apparatus of claim 1, including a radiator fan operably connected to the turbine.

11. The apparatus of claim 10, wherein the radiator fan increases speed as more heat is generated by the first machine component or the second machine component.

12. A cooling system for a machine, comprising:
a fluid pump configured to pump a fluid along a fluid path, wherein the fluid is in thermal communication with a first machine component and a second machine component, wherein the second machine component is downstream from the first machine component and has a static operating temperature equal to or higher than the first machine component;
a turbine oriented downstream from the second machine component along the fluid path and configured for rotation by the fluid;
a condenser oriented downstream from the turbine along the fluid path and operably connected to the fluid pump; and
an internal combustion engine operably connected to a drivetrain and configured to provide propulsion to the machine.

13. The system of claim 12, wherein the first machine component or the second machine component includes at least a portion of an engine cooling system.

14. The system of claim 12, wherein the first machine component or the second machine component includes at least a portion of an engine exhaust system.

15. The system of claim 12, wherein the first machine component or the second machine component includes at least a portion of machine electronics on the machine.

16. The system of claim 12, wherein the first machine component or the second machine component includes a battery.

17. A method for cooling machine components comprising the steps of:
pumping fluid along a fluid path in thermal communication with a first machine component and a second machine component, wherein the second machine component has a static operating temperature equal to or greater than the static operating temperature of the first machine component;
employing the fluid to power a turbine operably connected with the fluid;
condensing the fluid for reuse along the fluid path.

18. The method of claim 17, wherein the first machine component or the second machine component includes at least a portion of an engine exhaust system.

19. The method of claim 17, wherein the first machine component or the second machine component includes at least a portion of an engine cooling system.

20. The method of claim 19, wherein the first machine component or the second machine component includes at least a portion of machine electronics on the machine.
